(19) United States
(12) Patent Application Publication
(10) Pub. No.: US 2020/0231061 A1
(43) Pub. Date: Jul. 23, 2020

(54) MANAGEMENT DEVICE, MANAGEMENT METHOD, AND STORAGE MEDIUM

(71) Applicant: HONDA MOTOR CO., LTD., Tokyo (JP)

(72) Inventors: Iori Kanamori, Wako-shi (JP); Kentaro Nagoshi, Wako-shi (JP)

(21) Appl. No.: 16/737,947

(22) Filed: Jan. 9, 2020

(30) Foreign Application Priority Data
Jan. 21, 2019 (JP) 2019-007760

(51) Int. Cl. B60L 53/63; B60L 53/62; B60L 58/12; H02J 3/14; H02J 3/00

(52) U.S. Cl. CPC B60L 53/63; B60L 53/62; H02J 3/003; H02J 3/144; B60L 58/12

(57) ABSTRACT

A management device includes an acquirer configured to acquire charging information of a plurality of vehicles from the plurality of respective vehicles, the vehicles being rechargeable from the outside, a deriver configured to derive a power demand of the plurality of vehicles for each region on the basis of the plurality of pieces of charging information acquired by the acquirer, and a provider configured to provide power demand information based on the power demand to a power supplier.

### CROSS-REFERENCE TO RELATED APPLICATION

This application claims priority to and the benefit from Japanese Patent Application No. 2019-007760, filed on Jan. 21, 2019, the contents of which are hereby incorporated by reference into the present application.

### BACKGROUND OF THE INVENTION

### Field of the Invention

The present invention relates to a management device, a management method, and a storage medium.

### Description of Related Art

In recent years, electric vehicles have been widely used, and many electric vehicles are being supplied. These electric vehicles have a battery mounted therein and travel when the battery is charged with electricity. Therefore, a user of an electric vehicle, for example, charges the battery of the electric vehicle with electricity at a charging station provided at a certain location, a home, or the like.

Electricity that is accumulated in the battery of the electric vehicle is supplied by, for example, a power company. However, a timing at which the electric vehicle is charged with electricity is up to the user of the electric vehicle. Therefore, for example, when many users start charging electric vehicles all at once, the electricity supplied by the power company is insufficient. Accordingly, the power company is required to prepare an appropriate amount of power. On the other hand, for example, there is a technology for estimating an operation situation of an electric vehicle in a region on the basis of operation record data when an electric vehicle is operated (for example, Japanese Unexamined Patent Application, First Publication No. 2016-134160, hereinafter, referred to as “Patent Document 1”).

In the technology disclosed in Patent Document 1 above, since the operation situation of the electric vehicle is estimated on the basis of the operation record data, an actual state of the electric vehicle cannot be reflected and an amount of electricity required for charging the electric vehicle cannot be accurately obtained in some cases.

The present invention has been made in view of such circumstances, and an object of the present invention is to provide a management device, a management method, and a storage medium capable of accurately deriving an amount of electricity required for charging.

### SUMMARY OF THE INVENTION

A management device, a management method, and a storage medium according to the present invention have adopted the following configurations.

(1) A first aspect of the present invention is a management device including: an acquirer configured to acquire charging information of a plurality of vehicles from the plurality of respective vehicles, the vehicles being rechargeable from the outside; a deriver configured to derive a power demand of the plurality of vehicles for each region on the basis of a plurality of pieces of the charging information acquired by the acquirer; and a provider configured to provide power demand information based on the power demand to a power supplier.

(2) In the aspect (1), the provider is configured to provide the power demand information to a power supplier supplying electricity to the region.

(3) In the aspect (1) or (2), the acquirer is configured to acquire charging information of a vehicle not being charged.

(4) In any one of the aspects (1) to (3), the deriver is configured to derive a demand time when there is the power demand.

(5) In the aspect (4), the deriver is configured to derive a peak time of the power demand as the demand time.

(6) In any one of the aspects (1) to (5), the provider is configured to provide the power demand information when the derived power demand is equal to or greater than a predetermined threshold value.

(7) In any one of the aspects (1) to (6), the management device further includes: a statistical processor configured to generate statistical data on the basis of previously acquired charging information, wherein the deriver is configured to compare charging information acquired on a current day by the acquirer with the statistical data to derive the power demand.

(8) In the aspect (7), the deriver is configured to correct the statistical data to be matched with the charging information acquired on the day by the acquirer, to derive the power demand

(9) A second aspect of the present invention is a management method including: acquiring, by a computer, charging information of a plurality of vehicles from the plurality of respective vehicles, the vehicles being rechargeable from the outside; deriving, by the computer, power demand of the plurality of vehicles for each region on the basis of a plurality of pieces of the acquired charging information; and providing, by the computer, power demand information based on the power demand to a power supplier.

(10) A third aspect of the present invention is a computer-readable non-transitory storage medium that stores a program, the program causing a computer to: acquire charging information of a plurality of vehicles from the plurality of respective vehicles, the vehicles being rechargeable from the outside; derive a power demand of the plurality of vehicles for each region on the basis of a plurality of pieces of the acquired charging information; and provide power demand information based on the power demand to a power supplier.

According to (1) to (10), it is possible to accurately derive an amount of electricity required for charging.

According to (3), the charging information in various situations can be acquired.

According to (4) and (5), a time in which a large amount of electricity is required can be acquired.

According to (6), power demand information of which the necessity is high can be provided.

### BRIEF DESCRIPTION OF THE DRAWINGS

FIG. 1 is a diagram showing an example of a configuration and a usage environment of a management device according to an embodiment.

FIG. 2 is a diagram showing an example of a configuration of a vehicle.

FIG. 3 is a diagram showing an example of a transition of a current-day SOC in a vehicle.

FIG. 4 is a graph showing an example of current-day SOC transition data.

FIG. 5 is a diagram showing an example of statistical data.

FIG. 6 is a diagram showing a fitting process between the current-day SOC transition data and the statistical data.

FIG. 7 is a diagram in which processes that are executed in a statistical processor and a deriver are visualized.

FIG. 8 is a flowchart showing an example of a flow of a process that is executed by each unit of the management device.

FIG. 9 is a diagram including a graph showing an example of a transition of the required-amount-of-electricity prediction in an office district for one day.

FIG. 10 is a diagram including a graph showing an example of a transition of the required-amount-of-electricity prediction in a residential area for one day.

FIG. 11 is a diagram including a graph showing an example of a transition of the required-amount-of-electricity prediction for one week including a consecutive holiday period.

### DETAILED DESCRIPTION OF THE INVENTION

Hereinafter, embodiments of a management device, a management method, and a storage medium according to the present invention will be described with reference to the drawings. Although it is assumed that a vehicle 10 is an electric vehicle in the following description, the vehicle 10 may be a vehicle that is rechargeable from the outside, and may be a vehicle including a secondary battery that supplies power for traveling or may be a hybrid car or a fuel cell vehicle.

### [Overall Configuration]

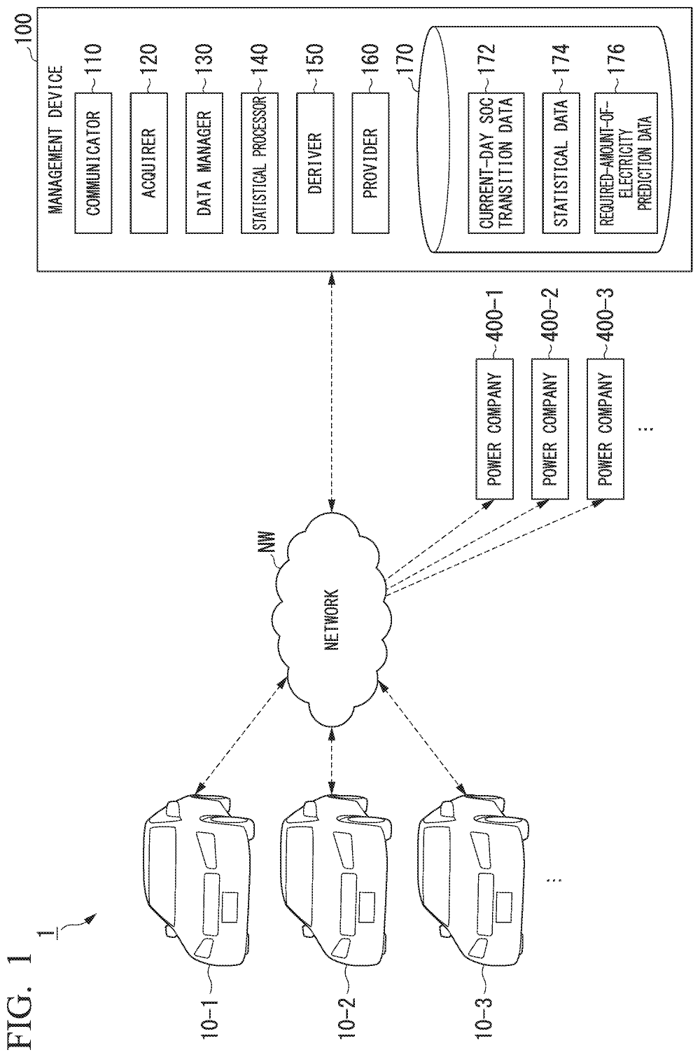

FIG. 1 is a diagram showing an example of a configuration and a usage environment of a management device 100 according to an embodiment. The management device 100 is a device that enables, for example, a power company, which is a power supplier, to prepare an appropriate electricity amount when supplying power to a battery (hereinafter synonymous with a secondary battery) mounted on a vehicle 10. As shown in FIG. 1, the management device 100 communicates with a plurality of vehicles 10 and a plurality of power companies 400 via a network NW. The network NW includes, for example, the Internet, a wide area network (WAN), a local area network (LAN), a provider device, or a wireless base station.

The management device 100 manages power on the basis of information transmitted by each of the plurality of vehicles 10 (10-1, 10-2, 10-3, . . . in FIG. 1; referred to as a vehicle 10 when the vehicles 10-1, 10-2, 10-3, . . . are not distinguished). The vehicle 10 and the management device 100 communicate via the network NW. The network NW includes, for example, the Internet, a wide area network (WAN), a local area network (LAN), a provider device, or a wireless base station. The management device 100 communicates with the plurality of power companies 400 via the network NW.

The plurality of power companies 400 (400-1, 400-2, 400-3, . . . in FIG. 1; referred to as a power company 400 when the power companies 400-1, 400-2, 400-3, . . . are not distinguished) supply power to regions assigned to the respective power companies. Here, the region may be defined in any way, may be defined in units of administrative divisions such as prefectures or municipalities, or may be defined in units of jurisdictions of substations.

### [Vehicle 10]

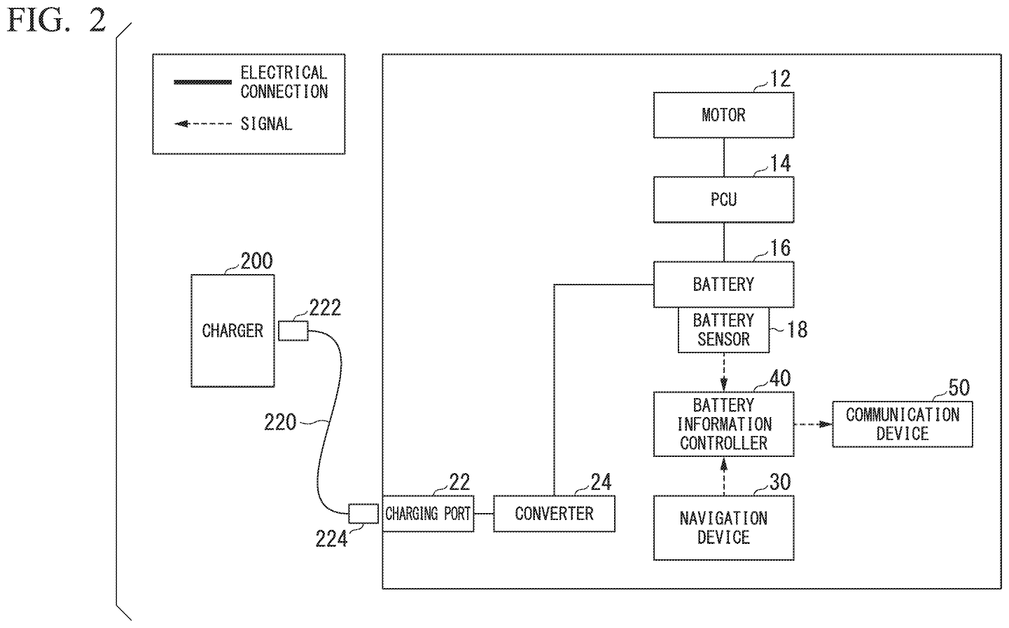

FIG. 2 is a diagram showing an example of a configuration of the vehicle 10. As shown in FIG. 2, the vehicle 10 includes, for example, a motor 12, a power control unit (PCU) 14, a battery 16, a battery sensor 18, a charging port 22, a converter 24, a navigation device 30, and a battery information controller 40, and a communication device 50.

The motor 12 is, for example, a three-phase AC motor. A rotor of the motor 12 is connected to drive wheels. The motor 12 rotates the driving wheel according to supplied power. The motor 12 generates electricity using kinetic energy of the vehicle when the vehicle is decelerated. The PCU 14 includes, for example, a control unit, and a DC-DC converter. The control unit, for example, calculates the power to be supplied to the motor 12 on the basis of detection values of various sensors provided in the vehicle. The DC-DC converter, for example, boosts power supplied from the battery 16, and supplies power calculated by the control unit to the motor 12.

The battery 16 is, for example, a secondary battery such as a lithium ion battery. The battery 16 stores power introduced from the charger 200 outside the vehicle 10 and performs discharging for traveling of the vehicle 10. The battery sensor 18 is, for example, a sensor group including a current sensor, a voltage sensor, and a temperature sensor. The battery sensor 18, for example, outputs a current value, a voltage value, and a temperature of the battery 16 to the battery information controller 40.

The charging port 22 is provided toward the outside of the vehicle 10. The charging port 22 is connected to the charger 200 via a charging cable 220. The charging cable 220 includes a first plug 222 and a second plug 224. The first plug 222 is connected to the charger 200, and the second plug 224 is connected to the charging port 22. Electricity supplied from the charger 200 is supplied to the charging port 22 via the charging cable 220. The charger 200 may be connectable to the network NW.

The charging cable 220 includes a signal cable provided in a power cable. The signal cable mediates communication between the vehicle 10 and the charger 200. Therefore, each of the first plug 222 and the second plug 224 is provided with a power connector and a signal connector.

The converter 24 is provided between the charging port 22 and the battery 16. The converter 24 converts a current introduced from the charger 200 through the charging port 22, for example, an AC current to a DC current. The converter 24 outputs the DC current after conversion to the battery 16.

The navigation device 30 includes, for example, a global navigation satellite system (GNSS) receiver, a navigation human machine interface (HMI), and a route determiner. The navigation device 30 holds map information in a storage device such as a hard disk drive (HDD) or a flash memory. A GNSS receiver specifies a position of the vehicle 10 that is a host vehicle on the basis of a signal received from a GNSS satellite. The navigation HMI includes a display device, a speaker, a touch panel, keys, and the like. The route determiner determines, for example, a route from the position of the host vehicle specified by the GNSS receiver (or any input position) to the destination input by the occupant using the navigation HMI by referring to the map information.

The navigation device 30 performs route guidance using the navigation HMI on the basis of an on-map route. The navigation device 30 outputs current position information regarding a current position of the specified position of the host vehicle, and destination information serving as the destination of the host vehicle to the battery information controller 40. The navigation device 30 may be realized, for example, by a function of a terminal device such as a smartphone or a tablet terminal possessed by the occupant. The navigation device 30 may transmit a current position and a destination to a navigation server via the communication device 50 and acquire the same route as the on-map route from the navigation server.

The battery information controller 40 calculates a state of charge (SOC) of the battery 16 on the basis of the current value, the voltage value, and the temperature of the battery 16 output by the battery sensor 18. The battery information controller 40 acquires the current value, the voltage value, the temperature, and the like of the battery 16 every predetermined time (for example, every 30 seconds or one minute), and calculates the SOC of the battery 16. When the battery information controller 40 calculates the SOC of the battery 16, the battery information controller 40 calculates an integrated value of a charging and discharging current of the battery and calculates a level of deterioration of the battery 16 at any time. The battery information controller 40 calculates the SOC of the battery 16 on the basis of the acquired integrated value of the charging and discharging current and the calculated level of deterioration.

The battery information controller 40 calculates the SOC regardless of whether the vehicle 10 is being stopped or traveling. The battery information controller 40 calculates the SOC even at the time of charging when the battery 16 of the vehicle 10 is being charged by the charger 200 or at the time of non-charging when the vehicle 10 is not being charged by the charger 200.

The battery information controller 40 generates charging information on the basis of the calculated SOC and the current position information and the destination information output by the navigation device 30. The battery information controller 40 stores vehicle ID information regarding a vehicle ID of the host vehicle. The battery information controller 40 includes the vehicle ID in the generated charging information and outputs the resultant charging information to the communication device 50. The battery information controller 40 transmits the charging information to the management device 100 via the charger 200 when communication between the vehicle 10 and the charger 200 is performed. The battery information controller 40 may transmit the charging information to the management device 100 via the communication device 50 even when the communication between the vehicle 10 and the charger 200 is performed.

The communication device 50 includes a wireless module for connection to a cellular network or a Wi-Fi network. The communication device 50 transmits the charging information output by the battery information controller 40 to the management device 100 via the network NW shown in FIG. 1. The communication device 50 transmits charging information to the management device 100 while the vehicle 10 is being charged or is traveling. Therefore, the communication device 50 transmits the charging information of the vehicle that is not being charged.

### [Management Device 100]

The management device 100 shown in FIG. 1 includes, for example, a communicator 110, an acquirer 120, a data manager 130, a statistical processor 140, a deriver 150, a provider 160, and a storage 170. The acquirer 120, the deriver 150, and the provider 160 are realized by a hardware processor such as a central processing unit (CPU) executing a program (software), for example. Some or all of these components may be realized by hardware (a circuit portion; including circuitry) such as a large scale integration (LSI), an application specific integrated circuit (ASIC), a field-programmable gate array (FPGA), or a graphics processing unit (GPU) or may be realized by software and hardware in cooperation. The program may be stored in a storage device (a non-transitory storage medium) such as a hard disk drive (HDD) or a flash memory in advance or may be stored in a detachable storage medium (a non-transitory storage medium) such as a DVD or a CD-ROM and installed by the storage medium being mounted in a drive device. The storage 170 is realized by the storage device described above.

The communicator 110 includes a communication interface such as an NIC. The communicator 110 receives the charging information respectively transmitted by the plurality of vehicles 10 via the network NW. The communicator 110 receives the charging information during charging or traveling, which is non-charging, of the vehicle 10. The communicator 110 outputs the received charging information to the acquirer 120.

When a process is performed by the management device 100, the plurality of vehicles 10 each calculate the SOC using the battery information controller 40, generate the charging information, and transmit the charging information to the management device 100 using the communication device 50. The vehicle 10 may perform the transmission of the charging information every predetermined time (for example, one minute, 30 minutes, or one hour), or may perform the transmission of the charging information on the basis of an instruction from the user of the vehicle 10. The vehicle 10 may perform the transmission of the charging information according to a request from the management device 100. The vehicle 10 may transmit the charging information when a predetermined condition is satisfied, for example, when the SOC of the battery 16 rapidly increases or decreases or when the SOC becomes less than a certain value. The vehicle 10 may transmit the charging information at any of these timings.

The acquirer 120 acquires the charging information output using the communicator 110. Thereby, the acquirer 120 acquires the charging information of the plurality of vehicles 10 that are rechargeable from the outside, from the plurality of vehicles 10. The acquirer 120 acquires a day of a week and holiday information, weather information, and construction and event information when the acquirer 120 has acquired the charging information, from an external server or the like. The acquirer 120 adds the acquired day of the week and holiday information, weather information, and construction and event information to the charging information, and outputs the charging information to the data manager 130.

The data manager 130 generates or updates current-day SOC transition data 172 for each predetermined update time on the basis of the charging information of the plurality of vehicles output by the acquirer 120, and stores a current-day SOC transition data 172 in the storage 170. Specifically, the data manager 130, for example, predicts a charging position on the basis of the current position information and the destination information included in the charging information, and distributes the charging information to each region including the predicted charging position. The data manager 130 accumulates the SOC included in the charging information for each region to which the charging information has been distributed, to generate the current-day SOC transition data 172.

The data manager 130 estimates a region in which there is a charging location at which the vehicle 10 is charged, on the basis of the current position information and the destination information included in the charging information when data manager 130 distributes the charging information to respective regions. The charging location at which the vehicle 10 is charged, for example, may be a current position of the vehicle 10 or may be a destination of the vehicle 10. The data manager 130 may estimate the charging position in consideration of a charging time in relation to the SOC. For example, the data manager 130 may estimate the current position as the charging location when the SOC is low, and estimate the destination as the charging location when the SOC is high. The data manager 130 may estimate the destination as the charging location when the destination is set and estimate the current position as the charging location when the destination is not set. A charging station or the like between the current position and the destination may be estimated as the charging location.

The data manager 130 generates the current-day SOC transition data 172 for 24 hours during a reset time set once a day. The reset time is a time at which accumulation of the SOC for generating the current-day SOC transition data 172 is reset. The SOC transition data is data indicating a transition of an average value of the SOC (hereinafter referred to as an “average SOC”) of the battery 16 in the plurality of vehicles 10. The reset time may be any time, such as 0:00 AM, 5:00 AM, or 12:00 AM. The reset time may be two or more times rather than once a day, or may be once every two, three, or more days.

The data manager 130 calculates an average SOC that is an average value of the SOCs included in the plurality of pieces of charging information output by the acquirer 120. For example, when an update time is 30 minutes and a previous update time is 13:00, the data manager 130 calculates, at 13:30, the average SOC of the SOCs included in the charging information output by the acquirer 120 for 30 minutes (from 13:00 to 13:30) after updating the current-day SOC transition data 172. The data manager 130 reads the current-day SOC transition data 172 generated by 13:00 from the storage 170, adds data of the average SOC at 13:30 to update the current-day SOC transition data 172, and stores the current-day SOC transition data 172 in the storage 170. The data manager 130 reads the current-day SOC transition data 172 from the storage 170, updates the current-day SOC transition data 172, and stores the current-day SOC transition data 172 in the storage 170 each time the update time is reached until the current-day SOC transition data 172 reaches a predetermined reset time.

The data manager 130 outputs, to the statistical processor 140, the current-day SOC transition data 172 for one day as previous-day SOC transition data together with the charging information used at the time of generation of the previous-day SOC transition data when the reset time has been reached. When the charging information is first output by the acquirer 120 after the reset time, the data manager 130 newly generates the current-day SOC transition data 172 and stores the current-day SOC transition data 172 in the storage 170.

FIG. 3 is a diagram showing an example of a transition of a current-day SOC for one day in the vehicle 10. A graph L10 shown in FIG. 3 is a graph showing an example of the transition of the current-day SOC. For example, the user of the vehicle 10 parks the vehicle 10 in a garage at home and charges the battery 16 of the vehicle 10 overnight. Therefore, in the morning, the battery 16 is substantially fully charged.

Thereafter, for example, when the user causes the vehicle 10 to travel for work attendance, the SOC of the battery 16 gradually decreases. Thereafter, for example, when the user arrives at a company and parks the vehicle 10 in a parking lot, the decrease in the SOC is stopped, and the SOC of the battery 16 increases by the user charging the battery 16.

Thereafter, when the user goes out due to business or the like and causes the vehicle 10 to travel, the SOC gradually decreases. Thereafter, when the user finishes the business, returns to the company and parks the vehicle in the parking lot of the company, the decrease in the SOC is stopped. In this case, since the battery 16 has not been charged, the SOC maintains a current state.

Thereafter, when the user finishes the business and causes the vehicle 10 to travel home, the SOC gradually decreases. The user returns home, parks the vehicle 10 in the garage at home, and charges the battery 16 of the vehicle 10 overnight. Thereby, the SOC increases. Thus, the battery 16 is substantially fully charged. and the day ends.

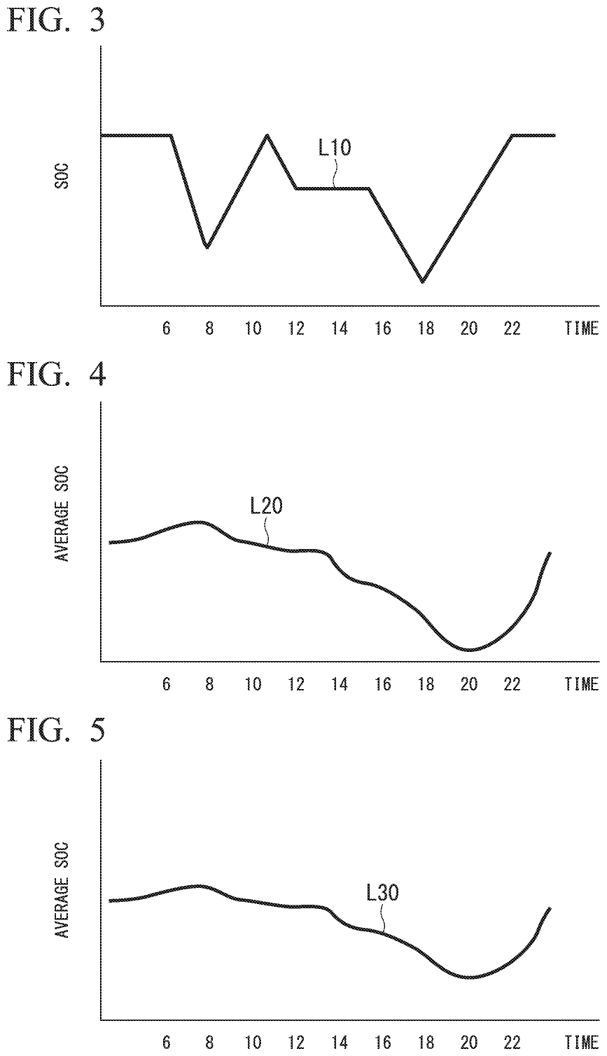

FIG. 4 is a diagram showing an example of the current-day SOC transition data 172. A graph L20 shown in FIG. 4 is a graph showing the current-day SOC transition data 172 on weekdays, in clear weather, and when there is no construction or event. An average SOC of the current-day SOC transition data 172 becomes the highest by an early time zone in the morning, and gradually decreases from 7:00 to about 8:00 when the user starts to be active. Thereafter, the average SOC slightly increases from about 12:00, and decreases after about 14:00 again. The decrease in the average SOC continues until about 20:00 when many users start charging, and thereafter, the average SOC increases. In the current-day SOC transition data 172 shown in FIG. 4, the average SOC reaches a peak at about 8:00 AM and reaches a valley at about 20:00.

The statistical processor 140 performs updating of the statistical data as statistical processing when the data manager 130 outputs the previous-day SOC transition data. The statistical data 174 is data based on previously acquired charging information. The statistical processor 140 updates the statistical data 174 for each region by referring to the current position information included in the charging information or the day of the day of a week and holiday information, weather information, and construction and event information added to the charging information.

For items of days of the day of a week and holidays for classifying the statistical data 174, for example, items such as “weekday,” “Saturday,” and “Sunday or holiday” are provided. For items of weather, for example, items such as “clear,” “cloudy,” “rain,” and “snow” are provided. For items of construction and events, for example, items such as “construction or event” and “no construction or event” are provided. The statistical processor 140 generates or updates, for example, statistical data 174 in which the item of the day of the day of a week or holiday is “weekday,” the item of weather is “clear,” and the item of construction and events is “no construction or event”.

When the statistical processor 140 updates the statistical data 174, the statistical processor 140 reads the statistical data 174 of the item of the day of the day of a week or holiday, the item of the weather, and the item of construction or events in a region corresponding to the previous-day SOC transition data in the statistical data 174 stored in the storage 170. The statistical processor 140 updates the statistical data 174 read from the storage 170 on the basis of the previous-day SOC transition data output by the data manager 130.

FIG. 5 is a diagram showing an example of the statistical data 174. A graph L30 shown in FIG. 5 is a graph showing the statistical data 174 at the time of “weekday,” “clear,” and “no” construction or event in the same region as a region in which the current-day SOC transition data 172 shown in FIG. 4 has been generated. In the statistical data 174 shown in FIG. 5, the average SOC becomes the highest by an early time zone in the morning and gradually decreases from about 7:00 to 8:00 when the user starts to be active, like the current-day SOC transition data 172 shown in FIG. 4. However, a variation amount (an increase amount or decrease amount) of the average SOC is smaller than that of the current-day SOC transition data 172 shown in FIG. 4.

Subsequently, there is a slight increase in the average SOC from about 12:00 to about 14:00, and then the average SOC continues to decrease until about 20:00, but the variation amount (the increase and decrease amount) of the average SOC is smaller than that of the current-day SOC transition data 172 shown in FIG. 4. Thus, the statistical data 174 varies in the same way as the current-day SOC transition data 172, but an amount of variation is smaller than that of the current-day SOC transition data 172.

The deriver 150 reads the current-day SOC transition data 172 and the statistical data 174 stored in the storage 170. The deriver 150 derives required-amount-of-electricity prediction data 176, which becomes the power demand for each region, on the basis of the read current-day SOC transition data 172 and statistical data 174. The deriver 150, for example, derives the required-amount-of-electricity prediction data 176 when a predetermined prediction execution timing is reached.

The prediction execution timing may be any timing. For example, the prediction execution timing may be a time determined as a fixed time, such as a time such as 10:00, 12:00, or 14:00, or may be a timing at which there is an input instruction from an input means (not shown) by an operator or the like. The prediction execution timing may be when the acquirer 120 has received prediction data request information for requesting the required-amount-of-electricity prediction data 176, which is transmitted from the power company 400. The prediction execution timing is preferably several hours before a time when a power demand increases. Since the power demand often increases at night, the prediction execution timing is preferably a time from noon to evening. The prediction execution timing is preferably a timing at which the current-day SOC transition data 172 is accumulated to some extent. Therefore, the reset time is preferably several hours before the predicted execution timing, such as a time between night and early morning.

The deriver 150 derives required-amount-of-electricity prediction data for each region by comparing the current-day SOC transition data 172 generated by the data manager 130 with the statistical data 174 generated by the statistical processor 140. The required-amount-of-electricity prediction data is an example of power demand information of the present invention. The deriver 150 derives, for example, a demand time in which there is power demand and, specifically, a peak time, a peak day, or the like when the power demand reaches a peak, as the required-amount-of-electricity prediction data 176. The deriver 150 further derives a peak average SOC in the peak time, and a peak SOC obtained by multiplying the peak average SOC by a total number of vehicles 10.

The deriver 150 corrects the statistical data 174 to be matched with the current-day SOC transition data 172 until a time that is the prediction execution timing. When the deriver 150 corrects the statistical data 174, the deriver 150 performs, for example, a fitting process using a least square method. Further, the deriver 150 performs the fitting process on the statistical data 174 so that a degree of matching is highest with respect to the current-day SOC transition data 172, for example, so that a square error is minimized The fitting process may be performed using a method other than the least square method.

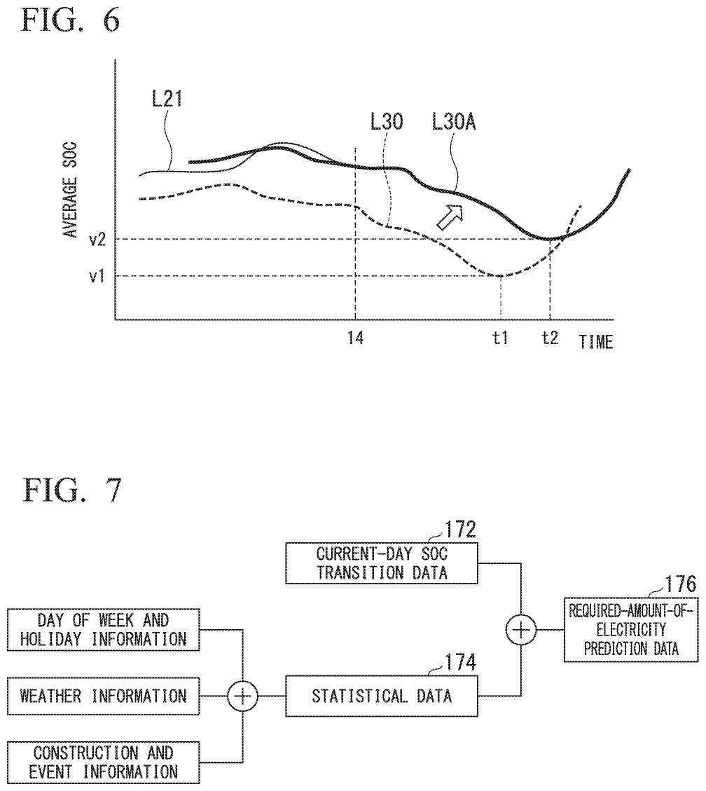

FIG. 6 is a diagram showing an example in which a fitting process is performed so that the statistical data 174 matches the current-day SOC transition data 172. A graph L21 in FIG. 6 shows the current-day SOC transition data 172 updated and generated by the data manager 130. A graph L30 indicated by a broken line indicates the statistical data 174 updated and generated by the statistical processor 140. A graph L30A indicated by a solid line shows the statistical data 174 after the fitting process has been performed. For example, when the prediction execution timing is 14:00, the deriver 150 moves the graph L21 and the graph L30 until 14:00 so that a degree of matching between the graph L21 and the graph L30A is the highest.

The peak time and the peak average SOC are corrected by moving the graph L30 to the graph L30A. In the example shown in FIG. 6, time tl was the peak time, and an average SOC v1 was the peak average SOC before correcting the statistical data 174. On the other hand, by correcting the statistical data 174, the peak time became time t2, which is later than time t1, and the peak average SOC became an average SOC v2, which is greater than the average SOC v1. The deriver 150 derives the thus corrected peak time and peak average SOC, and a peak SOC obtained by multiplying the peak average SOC by a total number 10 of vehicles 10 as the required-amount-of-electricity prediction data 176. The deriver 150 outputs the derived required-amount-of-electricity prediction data 176 to the provider 160.

Processes that are executed in the statistical processor 140 and the deriver 150 will be summarized as follows. FIG. 7 is a diagram visualizing the processes that are executed in the statistical processor 140 and the deriver 150. The statistical processor 140 generates, for each region, the statistical data 174 based on the previous-day SOC transition data distributed to the item of the day of the day of a week or holiday, the item of weather, and the item of construction or events. The deriver 150 generates the required-amount-of-electricity prediction data 176 by performing a fitting process on the statistical data 174 generated by the statistical processor 140 and the current-day SOC transition data 172.

The provider 160 outputs the required-amount-of-electricity prediction data 176 output by the deriver 150 to the communicator 110. The communicator 110 transmits the required-amount-of-electricity prediction data 176 output by the provider 160 to the power company 400. Thus, the provider 160 provides the required-amount-of-electricity prediction data 176 to the power company 400 via the communicator 110.

The provider 160 may not provide the required-amount-of-electricity prediction data 176 to the power company 400 when the required amount of electricity based on the required-amount-of-electricity prediction data 176 output by the deriver 150 is lower than a predetermined threshold value. In other words, the provider 160 provides the required-amount-of-electricity prediction data 176 to the power company 400 when the required amount of electricity based on the required-amount-of-electricity prediction data 176 is equal to or larger than the predetermined threshold value and the required amount of electricity increases. A case in which the required amount of electricity is smaller than the predetermined threshold value may be determined in any form. For example, a case in which the peak average SOC included in the required-amount-of-electricity prediction data 176 is lower than a predetermined threshold value may be the case in which the required amount of electricity is smaller than the predetermined threshold value, or a case in which the peak SOC is lower than a predetermined threshold value may be the case in which the required amount of electricity is smaller than the predetermined threshold value.

### [Power Company 400]

The power company 400 secures, for example, power that will be required in the future, on the basis of the required-amount-of-electricity prediction data 176 provided by the provider 160 of the management device 100. For example, the power company 400 increases an amount of generated power or purchases electricity in advance in a time zone in which power is cheap, before a time zone in which a required amount of electricity increases is reached, to secure the required amount of electricity. In a time zone in which the required amount of electricity is small, for example, the power company 400 decreases an amount of held electricity and achieves protection of a facility.

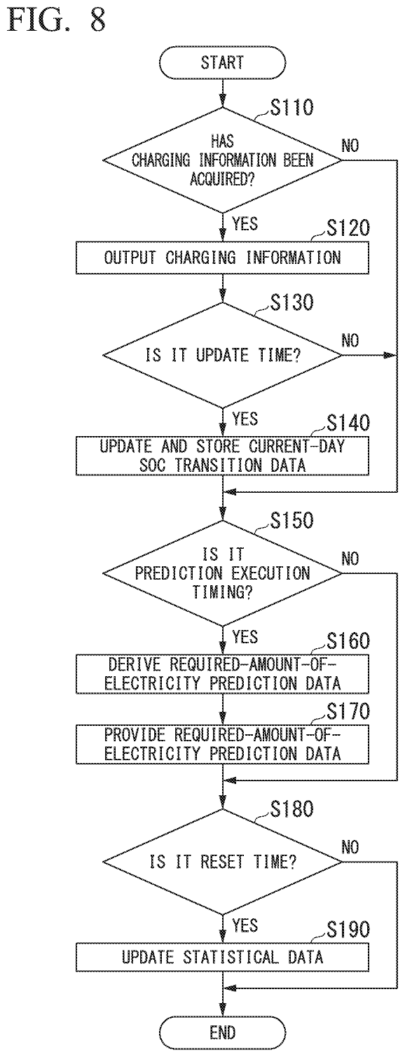

Next, a process of the management device 100 will be described. FIG. 8 is a flowchart showing an example of a flow of a process that is executed in the management device 100. The acquirer 120 determines whether or not the charging information transmitted by any of the plurality of vehicles 10 has been acquired (step S110). When the acquirer 120 has determined that the charging information has not been acquired, the management device 100 proceeds to a process of step 5150.

When the acquirer 120 has determined that the charging information has been acquired, the acquirer 120 outputs the acquired charging information to the data manager 130 (step S120). Subsequently, the data manager 130 determines whether the current time is an update time (step S130). When the data manager 130 has determined that the current time is not an update time, the data manager 130 proceeds to the process of step 5150. When the data manager 130 has determined that the current time is an update time, the data manager 130 distributes the charging information to respective regions, updates the current-day SOC transition data 172 for each region, and stores the current-day SOC transition data 172 in the storage 170 (step S140).

The deriver 150 determines whether or not it is the prediction execution timing (step S150). When the deriver 150 has determined that it is not the prediction execution timing, the deriver 150 proceeds to a process of step S180. When the deriver 150 has determined that it is the prediction execution timing, the deriver 150 derives the required-amount-of-electricity prediction data 176 on the basis of the current-day SOC transition data 172 and the statistical data 174 (step S160) and outputs the required-amount-of-electricity prediction data 176 to the provider 160. The provider 160 outputs the required-amount-of-electricity prediction data 176 derived by the deriver 150 to the communicator 110, and the communicator 110 transmits the received required-amount-of-electricity prediction data 176 to the power company 400. Thus, the provider 160 provides the required-amount-of-electricity prediction data 176 to the power company 400 (step S170).

Subsequently, the data manager 130 determines whether the current time it is a reset time (step S180). When the data manager 130 has determined that the current time is not a reset time, the management device 100 ends the process shown in FIG. 8 as it is. When the data manager 130 has determined that the current time is a reset time, the data manager 130 outputs the current-day SOC transition data 172 to the statistical processor 140 as the previous-day SOC transition data. The statistical processor 140 updates the statistical data 174 on the basis of the previous-day SOC transition data output by the data manager 130 (step S190). Thus, the management device 100 ends the process shown in FIG. 8.

The required-amount-of-electricity prediction data 176 may have a characteristic, for example, in relation with a region or date. Hereinafter, examples of a transition of the required amount of electricity in an office district and a residential area for one day and an example of a transition of the required-amount-of-electricity prediction in a period including consecutive holidays will be described by way of example.

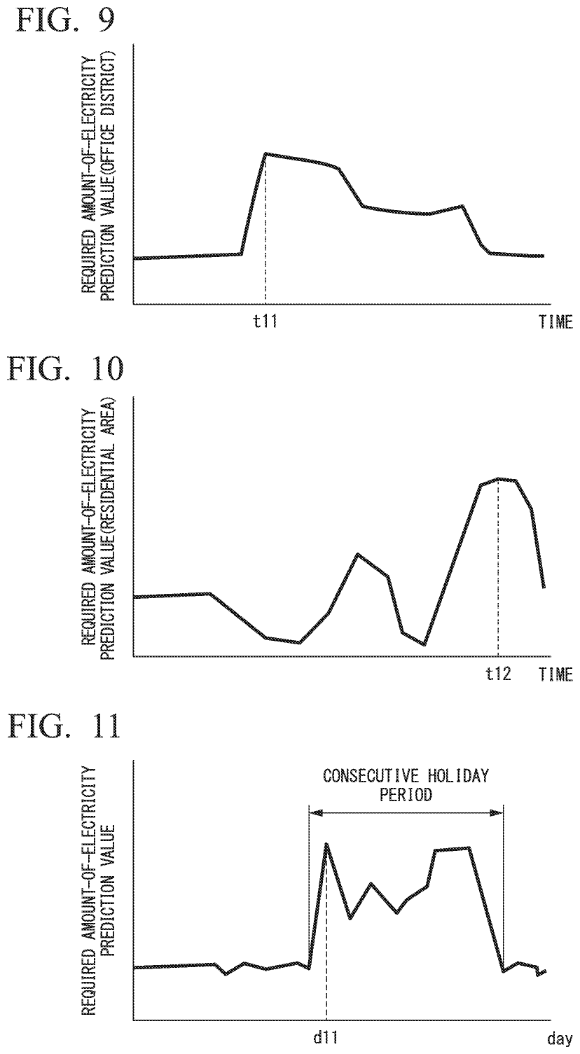

FIG. 9 is a diagram including a graph showing an example of a transition of the required-amount-of-electricity prediction in an office district for one day. In the prediction of the required amount of electricity in the office district, for example, the required amount of electricity is concentrated in a time zone in the morning in which work attendance is concentrated, and reaches a peak in a peak time t11. Thereafter, the required amount of electricity transitions with a slight variation while showing a gradual decreasing trend.

FIG. 10 is a diagram including a graph showing an example of a transition of the required-amount-of-electricity prediction in a residential area for one day. In the prediction of the amount of electricity required in the residential area, for example, the required amount of electricity is small in the morning when there is little motion of residents or the like, and the required amount of electricity increases in an early time zone in the afternoon when the motion of residents or the like is active. Thereafter, the required amount of electricity decreases over time. However, the required amount of electricity increases in a late time zone in the afternoon when the number of residents or the like returning to home increases, and the required amount of electricity increases at midnight and reaches a peak at peak time t12. Thereafter, a required amount-of-electricity prediction value decreases by charging starting to be gradually completed.

FIG. 11 is a diagram including a graph showing an example of a transition of the required-amount-of-electricity prediction for one week including a consecutive holiday period. In this example, a second half of a week is the consecutive holiday period. The required amount of electricity transitions with a small amount in a first half of the week before the consecutive holiday period is reached, greatly increases in the middle of the week in which the consecutive holiday period starts, and then, reaches a peak day d11. The required amount of electricity during the consecutive holiday period varies while increasing from that in the first half of the week. Thereafter, when the consecutive holiday period ends in the second half of the week, the required amount of electricity greatly decreases and becomes the same level as before the consecutive holiday period in the first half of the week.

According to the embodiment described above, the management device 100 derives the power demand on the basis of the charging information transmitted by the plurality of vehicles 10. The charging information is acquired from the plurality of vehicles 10. The SOC information included in the charging information is obtained on the basis of a detection value actually detected by the battery sensor 18. Therefore, the management device 100 can accurately derive the amount of electricity required for charging.

The current position information and the destination information are included in the charging information. Therefore, the management device 100 can accurately derive the amount of electricity required for charging for each region. The vehicle 10 transmits the charging information to the management device 100 during non-charging, such as during traveling. Therefore, since the management device 100 can acquire the charging information in various situations, the management device 100 can derive the amount of electricity required for charging more accurately.

Although the form for implementing the present invention has been described using the embodiments, the present invention is not limited to such embodiment at all, and various modifications and substitutions can be made without departing from the gist of the present invention.

What is claimed is:

1. A management device comprising:
an acquirer configured to acquire charging information of a plurality of vehicles from the plurality of respective vehicles, the vehicles being rechargeable from the outside;
a deriver configured to derive a power demand of the plurality of vehicles for each region on the basis of a plurality of pieces of the charging information acquired by the acquirer; and
a provider configured to provide power demand information based on the power demand to a power supplier.

2. The management device according to claim 1, wherein the provider is configured to provide the power demand information to a power supplier supplying electricity to the region.

3. The management device according to claim 1, wherein the acquirer is configured to acquire charging information of a vehicle not being charged.

4. The management device according to claim 1, wherein the deriver is configured to derive a demand time when there is the power demand

5. The management device according to claim 4, wherein the deriver is configured to derive a peak time of the power demand as the demand time.

6. The management device according to claim 1, wherein the provider is configured to provide the power demand information in a case where the derived power demand is equal to or greater than a predetermined threshold value.

7. The management device according to claim 1, further comprising:
a statistical processor configured to generate statistical data on the basis of previously acquired charging information,
wherein the deriver is configured to compare charging information acquired on a current day by the acquirer with the statistical data to derive the power demand.

8. The management device according to claim 7, wherein the deriver is configured to correct the statistical data to match the charging information acquired on a current day by the acquirer, to derive the power demand.

9. A management method using a computer, comprising:
acquiring charging information of a plurality of vehicles from the plurality of respective vehicles, the vehicles being rechargeable from the outside;
deriving power demand of the plurality of vehicles for each region on the basis of a plurality of pieces of the acquired charging information; and
providing power demand information based on the power demand to a power supplier.

10. A computer-readable non-transitory storage medium that stores a program, the program causing a computer to:
acquire charging information of a plurality of vehicles from the plurality of respective vehicles, the vehicles being rechargeable from the outside;
derive a power demand of the plurality of vehicles for each region on the basis of a plurality of pieces of the acquired charging information; and
provide power demand information based on the power demand to a power supplier.
